(19) United States
(12) Patent Application Publication
(10) Pub. No.: US 2004/0198399 A1
(43) Pub. Date: Oct. 7, 2004

(54) Cellular phone base and a wireless earphone capable of switching cellular phone and cordless phone communications

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/406,203

(22) Filed: Apr. 4, 2003

(51) Int. Cl. H04Q 7/20; H04M 1/00

(52) U.S. Cl. 455/462; 455/552.1

(57) ABSTRACT

A cellular phone base capable of switching cellular phone and cordless phone communications is disclosed. The cellular phone base comprises a telephone interface connected to a telephone line; a cellular phone interface connected to a cellular phone; a control unit installed in the cellular phone base; a transmission/reception unit connected to the control unit, the transmission/reception unit being under control of the control unit and communicating with a corresponding wireless earphone; and at least one switch connected to the telephone interface, the cellular phone interface, the control unit, and the transmission/reception unit, wherein the switch normally connects the transmission/reception unit with the cellular phone interface, and when the telephone interface is connected to the control unit, a signal is sent to the control unit to switch the switch such that the transmission/reception unit is connected to the telephone interface.

### BACKGROUND OF THE INVENTION

1. Field of the Invention

The present invention relates to a cellular phone base and a wireless earphone capable of switching cellular phone and cordless phone communications. More particularly, the present invention relates to a portable transceiver device capable of switching cellular phone and cordless phone communications.

2. Description of the Prior Art

The major advantage of a cellular phone is its high portability. When using a cellular phone in a car, in order to refill its internal battery and also to use the car antenna to increase the communication efficiency, the cellular phone is usually connected to the car through a socket built in the lower part of the cellular phone and a signal cable provided by the telephone vendor. Once the cellular phone is connected to the car, the phone will automatically disconnect its internal antenna and connect its telephone circuit to the car antenna. Typically, the cellular phone is powered by plugging into an electric cigarette lighter. Plugs can be directly plugged into some electrical devices whereas connecting devices are needed for certain other electrical devices. Electrical devices that lack a connecting device must be small but may still often seriously interfere with operation of parts of the car such as the stick shift.

Hitherto, none of the prior art has disclosed a cellular phone base and a wireless earphone capable of switching cellular phone and cordless phone communications.

### SUMMARY OF THE INVENTION

The main objective of the invention is to provide a cellular phone base and a wireless earphone capable of switching cellular phone and cordless phone communications.

According to the claimed invention, a cellular phone base capable of switching cellular phone and cordless phone communications is disclosed. The cellular phone base comprises a telephone interface connected to a telephone line; a cellular phone interface connected to a cellular phone; a control unit installed in the cellular phone base; a transmission/reception unit connected to the control unit, the transmission/reception unit being under control of the control unit and communicating with a corresponding wireless earphone; and at least one switch connected to the telephone interface, the cellular phone interface, the control unit, and the transmission/reception unit, wherein the switch normally connects the transmission/reception unit with the cellular phone interface, and when the telephone interface is connected to the control unit, a signal is sent to the control unit to switch the switch such that the transmission/reception unit is connected to the telephone interface.

From one aspect of the present invention, a wireless earphone capable of switching cellular phone and cordless phone communications is disclosed. The wireless earphone comprises an input device for inputting voice signals; a control unit installed in the wireless earphone; a switching unit connected to the control unit, wherein when the switching unit is pressed, voice volume and frequency channels can be adjusted; a keypad unit connected to the control unit, the keypad unit comprising a plurality of buttons; a transmission/reception unit connected to the input device and the control unit, the transmission/reception unit being under control of the control unit and communicating with a corresponding cellular phone base; and an output device connected to the control unit, wherein the output device is used to transmit signals received by the transmission/reception unit under the control of the control unit.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a block diagram illustrating the circuit of a cellular phone base 1 according to the present invention.

FIG. 2 is a circuit block diagram of the wireless earphone 2 according to the present invention.

### DETAILED DESCRIPTION OF THE PREFERRED EMBODIMENT

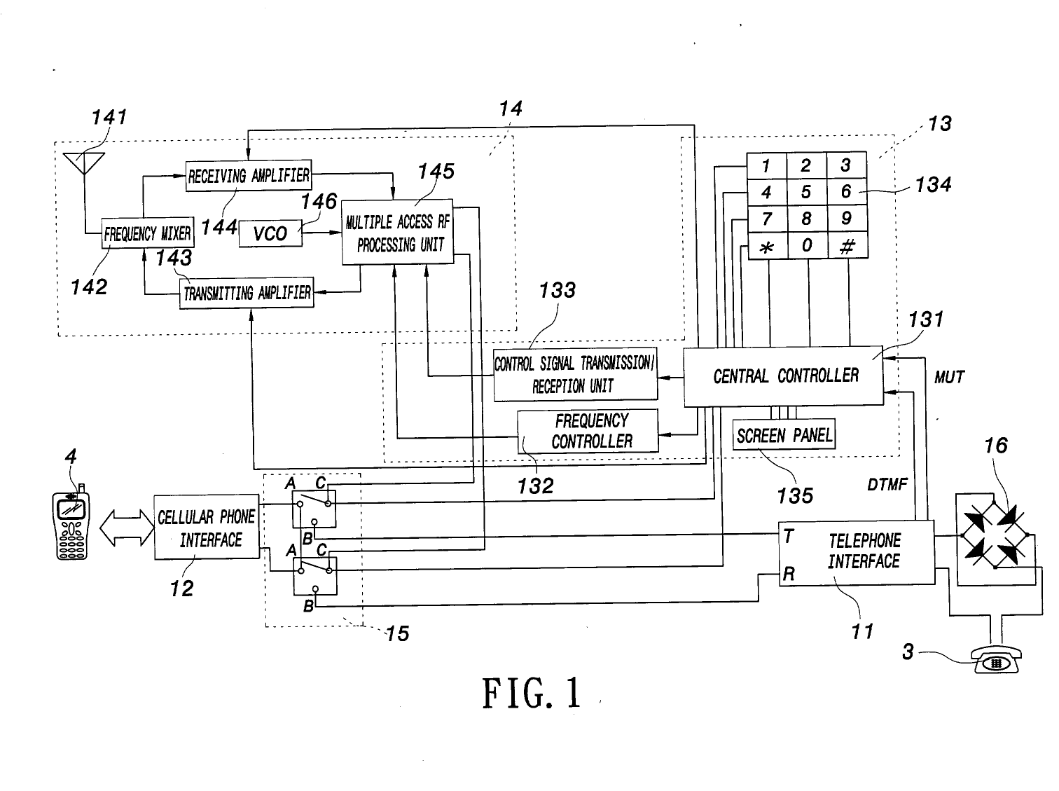

Please refer to FIG. 1. FIG. 1 is a block diagram illustrating the circuit of a cellular phone base 1 according to the present invention. The cellular phone base 1 comprises a telephone interface 11, a cellular phone interface 12, a control unit 13, a transmission/reception unit 14, and two switches 15.

The telephone interface 11 is electrically connected to a typical telephone line of a telephone 3 through a rectifying circuit 16. The telephone 3 may be a cordless telephone or a cable telephone.

The cellular phone interface 12 is connected to a portable cellular phone 4. Through the cellular phone interface 12, the voice signals sent from the cellular phone 4 can be transmitted to the cellular phone base 1. Or, signals can be sent from the cellular phone base 1 through the cellular phone interface 12 to the portable cellular phone 4.

The control unit 13 consists of a central controller 131, a frequency controller 132, and a control signal transmission/reception section 133. The control unit 13 is the heart of the cellular phone base 1.

The transmission/reception unit 14 is connected to the control unit 13. The transmission/reception unit 14 comprises an antenna 141, a frequency mixer (SAW) 142, a transmitting amplifier 143, a receiving amplifier 144, a multiple access RF processing unit 145, and a voltage control oscillator (VCO) 146. The transmission/reception unit 14 is controlled by the control unit 13 and communicates with a wireless earphone 2 when communication code is correct during transmission.

The two switches 15 are electrically connected to the telephone interface 11, the cellular phone interface 12, the control unit 13, and the transmission/reception unit 14. There are joints a, b, and c in the two switches 15. Normally, the joint c is connected to the joint a. In this case, the multiple-access RF processing unit 145 of the transmission/reception unit 14 is connected to the cellular phone interface 12.

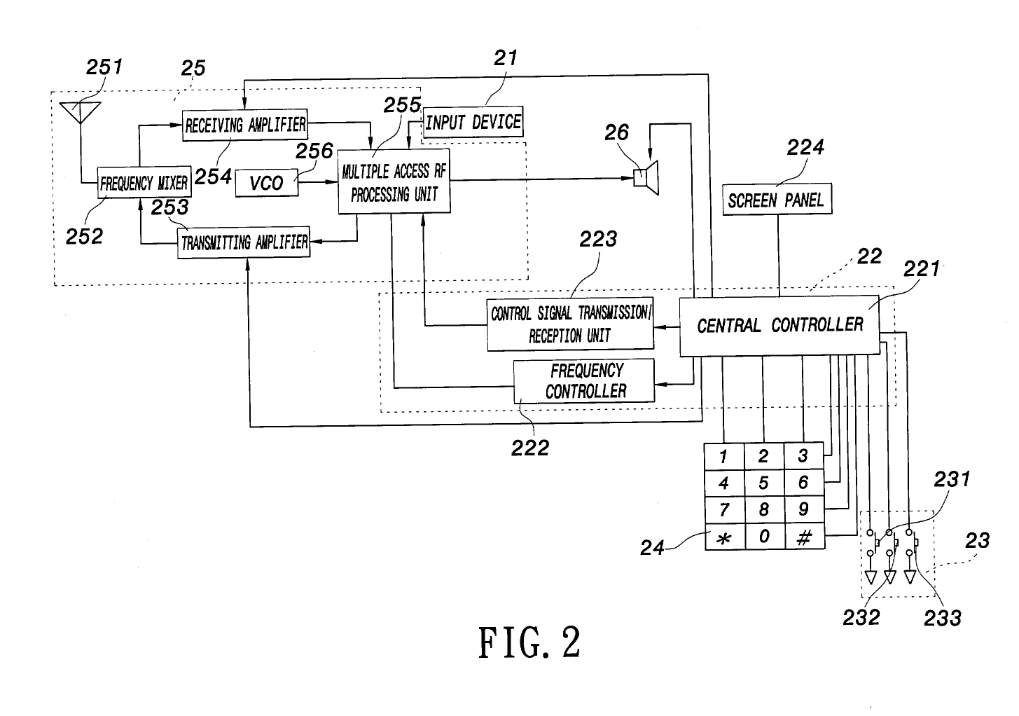

Please refer to FIG. 2. FIG. 2 is a circuit block diagram of the wireless earphone 2 according to the present invention. The wireless earphone 2 according to the present invention comprises an input device 21, a control unit 22, a switching unit 23, a keypad unit 24, a transceiver unit 25, and an output device 26.

The input device 21 may be a microphone for a user to input voice signals.

The control unit 22 consists of a central controller 221, a frequency controller 222, and a control signal transmission/reception unit 223.

The keypad unit 24 is electrically connected to the control unit 22. The keypad unit 24 comprises a plurality of input buttons for dialing.

The switching unit 23 is electrically connected to the control unit 22. The switching unit 23 comprises an audio switch 231 and a frequency switch 232. The audio switch 231 may be used to adjust the volume of audio output signals. The frequency switch 232 is used to select different receiving frequencies.

The transceiver unit 25 is electrically connected to the input device 21 and the control unit 22. The transceiver unit 25 consists of an antenna 251, a frequency mixer 252, a transmitting amplifier 253, a receiving amplifier 254, a multiple access RF processing unit 255, and a voltage control oscillator 256. The transceiver unit 25 is controlled by the control unit 22 and communicates with the cellular phone base 1.

The output device 26 is electrically connected to the control unit 22. The output device 26 may be an earphone or a speaker. The output device 26 is used to output the signals received by the transceiver unit 25. The output device 26 is controlled by the control unit 22.

According to another preferred embodiment of the present invention, the central controller 221 of the control unit 22 is electrically connected to a screen panel 224 for displaying incoming calls.

Accordingly, when receiving a call, the cellular phone 4 transmits the voice signals to the transmission/reception unit 14 of the cellular phone base 1 through the telephone interface 11. At the same time, the cellular phone 4, which is controlled by the control unit 13, transmits the voice signals to the transceiver unit 25 of the wireless earphone 2. The voice signals received by the transceiver unit 25 of the wireless earphone 2 will be transmitted to the output device 26, then to a user. Likewise, the user can talk through the input device 21 of the wireless earphone 2. In this case, the voice signals are transmitted to the transceiver unit 25, and then transmitted to the transmission/reception unit 14 of the cellular phone base 1 under the control of the control unit 22, then transmitted to the cellular phone 4 through the cellular phone interface 12 under the control of the control unit 13. Alternatively, the user can push the audio switch 231 of the switching unit 23 to adjust the volume. Also, he or she can push the frequency switch 232 to select different frequency channels.

When the central controller 131 of the control unit 13 is connected to the telephone interface 11, the telephone interface 11 sends DTMF and MUT signals. At the same time, the central controller 131 triggers the switch 15 to connect joint c with joint b, such that the multiple-access RF processing unit 145 is connected to the telephone interface 11. The user can dial through the keypad unit 24 of the wireless earphone 2. Signals are transmitted to the cellular phone base 1 and rectified at the telephone interface 11 and then inputted into the telephone 3. Accordingly, the wireless earphone 2 acts as a wireless earphone of the telephone 3.

Furthermore, the switching unit 23 of the wireless earphone 2 may further comprise a wireless phone switch 233. When one pushes the wireless phone switch 233, the control unit 22 will discern any sent code from the cordless telephone 3. If the code is correct, the wireless earphone 2 communicates with the cordless telephone 3 and thus the wireless earphone 2 becomes a handset of the cordless telephone 3.

To sum up, in accordance with the disclosed invention, the wireless earphone 2 not only prevents high frequency harm but increase the integrity between the telephone 3 and cellular phone 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cellular phone base capable of switching cellular phone and cordless phone communications, comprising:
a telephone interface connected to a telephone line;
a cellular phone interface connected to a cellular phone;
a control unit installed in the cellular phone base;
a transmission/reception unit connected to the control unit, the transmission/reception unit being under control of the control unit and communicating with a corresponding wireless earphone; and
at least one switch connected to the telephone interface, the cellular phone interface, the control unit, and the transmission/reception unit, wherein the switch normally connects the transmission/reception unit with the cellular phone interface, and when the telephone interface is connected to the control unit, a signal is sent to the control unit to switch the switch such that the transmission/reception unit is connected to the telephone interface.

2. The cellular phone base capable of switching cellular phone and cordless phone communications as claimed in claim 1 wherein the telephone interface connected to a telephone line through a rectifying circuit.

3. The cellular phone base capable of switching cellular phone and cordless phone communications as claimed in claim 1 wherein the control unit consists of a central controller, a frequency controller, and a control signal transmission/reception unit.

4. The cellular phone base capable of switching cellular phone and cordless phone communications as claimed in claim 1 wherein the control unit further comprises a keypad unit and a screen panel, wherein the keypad unit comprises a plurality of buttons and the screen panel is used to display calls.

5. The cellular phone base capable of switching cellular phone and cordless phone communications as claimed in claim 1 wherein the transmission/reception unit consists of an antenna, a frequency mixer (SAW), a transmitting amplifier, a receiving amplifier, a multiple access RF processing unit, and a voltage control oscillator (VCO).

6. The cellular phone base capable of switching cellular phone and cordless phone communications as claimed in claim 1 wherein the telephone interface transmits DTMF and MUT signals.

7. A wireless earphone capable of switching cellular phone and cordless phone communications, comprising:
an input device for inputting voice signals;
a control unit installed in the wireless earphone;
a switching unit connected to the control unit, wherein when the switching unit is pressed, voice volume and frequency channels can be adjusted;
a keypad unit connected to the control unit, the keypad unit comprising a plurality of buttons;
a transmission/reception unit connected to the input device and the control unit, the transmission/reception unit being under control of the control unit and communicating with a corresponding cellular phone base; and
an output device connected to the control unit, wherein the output device is used to transmit signals received by the transmission/reception unit under the control of the control unit.

8. The wireless earphone capable of switching cellular phone and cordless phone communications as claimed in claim 7 wherein the input device is a microphone.

9. The wireless earphone capable of switching cellular phone and cordless phone communications as claimed in claim 7 wherein the control unit consists of a central controller, a frequency controller, and a control signal transmission/reception unit.

10. The wireless earphone capable of switching cellular phone and cordless phone communications as claimed in claim 7 wherein the control unit is further connected to a screen panel to display calls.

11. The wireless earphone capable of switching cellular phone and cordless phone communications as claimed in claim 7 wherein the transmission/reception unit consists of an antenna, a frequency mixer (SAW), a transmitting amplifier, a receiving amplifier, a multiple access RF processing unit, and a voltage control oscillator (VCO).

12. The wireless earphone capable of switching cellular phone and cordless phone communications as claimed in claim 7 wherein the switching unit further comprises:
an audio switch for adjusting voice volume; and
a frequency switch for selecting different frequency channels.

13. The wireless earphone capable of switching cellular phone and cordless phone communications as claimed in claim 7 wherein the switching unit further comprises a cordless phone switch, and when the cordless phone switch is pressed, the control unit discerns sent code from a designated cordless phone and communicates with the cordless phone.

14. The wireless earphone capable of switching cellular phone and cordless phone communications as claimed in claim 7 wherein the output device is an earphone or a speaker.
